(19) United States
(12) Patent Application Publication
(10) Pub. No.: US 2021/0061603 A1
(43) Pub. Date: Mar. 4, 2021

(54) IMAGE FORMING DEVICE

(71) Applicant: Konica Minolta, Inc., Tokyo (JP)

(72) Inventors: Yutaka YAMAMOTO, Shinshiro-shi (JP); Akinori KIMATA, Toyokawa-shi (JP); Hiroshi EGUCHI, Toyohashi-shi (JP); Yuji KOBAYASHI, Toyohashi-shi (JP); Natsuyo IDA, Toyokawa-shi (JP); Yasuhiro ISHIHARA, Toyohashi-shi (JP)

(21) Appl. No.: 17/004,527

(22) Filed: Aug. 27, 2020

(30) Foreign Application Priority Data
Aug. 29, 2019 (JP) 2019-156379

(51) Int. Cl. B65H 7/14

(52) U.S. Cl. CPC B65H 7/14; B65H 2701/1916; B65H 2553/822; B65H 2553/30

(57) ABSTRACT

An image forming device including an optical sensor, an ultrasound sensor, and a conveyance guide. The optical sensor and the ultrasound sensor are disposed alongside a conveyance path of a sheet and are used to determine sheet type. The conveyance guide guides the sheet along the conveyance path. The conveyance guide is structured such that, on the conveyance path between the optical sensor and the ultrasound sensor, the sheet is in contact with the conveyance guide while a portion of the sheet is in a light irradiation range of the optical sensor and a different portion of the sheet is in an ultrasound irradiation range of the ultrasound sensor.

### CROSS REFERENCE TO RELATED APPLICATIONS

The present invention claims priority under 35 U.S.C. § 119 to Japanese Patent Application No. 2019-156379, filed on Aug. 29, 2019, the entire content of which is incorporated herein by reference.

### BACKGROUND

### Technical Field

The present disclosure relates to image forming devices, and in particular to techniques for improving media detection accuracy when using both an optical sensor and an ultrasound sensor to detect media.

### Description of the Related Art

An electrophotographic image forming device thermally fixes a toner image to a sheet. In order to secure good image fixing quality, fixing conditions must be set, such as fixing temperature and sheet conveyance speed, according to sheet type (for example, material, thickness, basis weight, surface condition, etc.) By changing such settings to appropriate values, a good image fixing quality can be secured. Thus, it is necessary to determine sheet type before heat fixing. For this reason, measures are taken such as allowing a user to set a sheet type or distinguishing sheet type using a sensor.

For example, if a sheet is illuminated, and an optical sensor used to detect reflected light, transmitted light, or both reflected and transmitted light, a surface condition of a sheet can be determined from a detected light amount. Further, if a sheet is irradiated with ultrasound waves, and an ultrasound sensor used to detect reflected ultrasound waves, transmitted ultrasound waves, or both reflected and transmitted ultrasound waves, thickness and basis weight of the sheet can be determined from a detected intensity of ultrasound. Further, in recent years, in response to an increase in the number of different types of sheet used in printing, sheet type can be determined accurately by determining sheet surface condition, thickness, and basis weight to set appropriate fixing conditions. It has become possible to set appropriate processing conditions for image formation (for example, temperature of a fixing unit, sheet speed, voltage of a secondary transfer unit, etc.)

However, when a sheet is irradiated with ultrasound waves, the sheet vibrates due to the ultrasound waves. If a sheet vibrates while a light amount is being detected by using an optical sensor, reflected and transmitted light will be diffused and an amount of detected light will become unstable, which may reduce accuracy when detecting a surface condition of the sheet. Such a decrease in detection accuracy causes a problem in that processing conditions cannot be set to appropriate values. For example, if temperature of a fixing unit is not set to an appropriate value, image fixing quality decreases.

To address such a problem, for example, a countermeasure has been proposed in which a conveyance roller is provided on a conveyance path of a sheet between an optical sensor and an ultrasound sensor, forming a conveyance nip which the sheet passes through (for example, see JP 2009-029622). In this way, it is possible to suppress propagation of vibration of a sheet from a position of ultrasonic wave irradiation to a position of detection of irradiated light, and therefore a decrease in detection accuracy of the optical sensor can be prevented.

However, rollers have problems such as eccentricity from the time of manufacture, abrasion due to conveyance of thick sheets, and sheet slippage due to adhesion of paper dust. If a sheet is conveyed while a roller is in a deteriorated state, the conveyed sheet will not be stably held, and the sheet may become unstable. If the sheet is not stable during media detection, detection accuracy deteriorates, and a type of conveyed sheet may not be correctly detected.

### SUMMARY

The present disclosure is provided in view of the technical problems described above, and an object of the disclosure is to provide an image forming device that can suppress a decrease in detection accuracy of an optical sensor due to the use of an ultrasound sensor even while a sheet is being conveyed.

In order to achieve at least the above-described object, an image forming device reflecting an aspect of the present disclosure is an image forming device including an optical sensor, an ultrasound sensor, and a conveyance guide. The optical sensor and the ultrasound sensor are disposed alongside a conveyance path of a sheet and are used to determine sheet type, and the conveyance guide guides the sheet along the conveyance path. The conveyance guide is structured such that, on the conveyance path between the optical sensor and the ultrasound sensor, the sheet is in contact with the conveyance guide while a portion of the sheet is in a light irradiation range of the optical sensor and a different portion of the sheet is in an ultrasound irradiation range of the ultrasound sensor.

### BRIEF DESCRIPTION OF THE DRAWINGS

The advantages and features provided by one or more embodiments of the disclosure will become more fully understood from the detailed description given hereinbelow and the appended drawings which are given by way of illustration only, and thus are not intended as a definition of the limits of the invention. In the drawings:

FIG. 1 is a diagram illustrating a structure of an image forming device pertaining to an embodiment of the present disclosure.

FIG. 2 is a schematic diagram of a conveyance path of a sheet S from a sheet source to a timing roller pair 124, viewed from a width direction of the sheet S.

FIG. 3 is a diagram illustrating a structure of an optical sensor 210.

FIG. 4 is a diagram illustrating a structure of an ultrasound sensor 220.

FIG. 5 is a block diagram illustrating a structure of a controller 151.

FIG. 6 is a flowchart describing operations of the controller 151.

FIG. 7 is an example table of sheet type identification.

FIG. 8 is a diagram illustrating a conveyance path of a sheet S fed from a first sheet feed cassette 131a.

FIG. 9 is a diagram illustrating a conveyance path of a sheet S fed from a manual feed tray.

FIG. 10 is a diagram illustrating a conveyance path of a sheet S fed from a second feed cassette 131b.

FIG. 11 is a diagram illustrating a modification in which a protrusion 1101 elongated in a sheet width direction is provided on a step 204 of a conveyance guide 202.

FIG. 12A, FIG. 12B, and FIG. 12C are diagrams illustrating a modification in which a protrusion 1201 elongated in a sheet conveyance direction is provided upstream in the sheet conveyance direction from the step 204 of the conveyance guide 202; FIG. 12A is a plan view diagram from a direction perpendicular to a sheet surface of a sheet S during conveyance; FIG. 12B is a cross-section diagram from the sheet width direction; and FIG. 12C is an enlargement of a portion of FIG. 12B outlined by a dotted line 1210.

### DETAILED DESCRIPTION

Hereinafter, one or more embodiments of the present disclosure will be described with reference to the drawings. However, the scope of the invention is not limited to the disclosed embodiments.

[1] Image Forming Device Structure

The following describes structure of an image forming device pertaining to an embodiment.

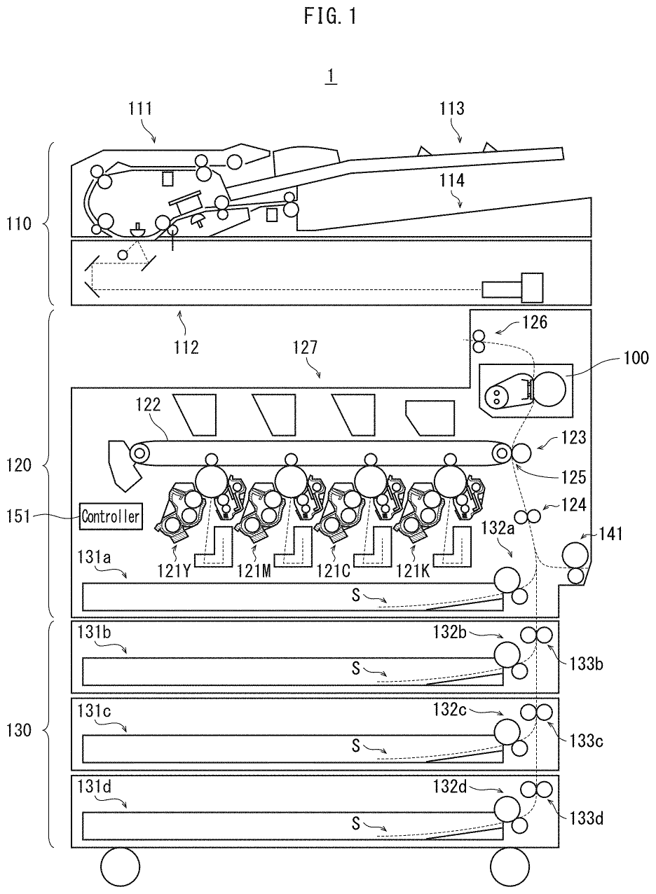

As illustrated in FIG. 1, an image forming device 1 is a tandem-type color multifunction peripheral (MFP), and includes an image reader 110, an image former 120, and a sheet feeder 130.

The image reader 110 includes an automatic document feeder (ADF) 111 and a scanner 112. The automatic document feeder 111 feeds documents stacked on a document tray 113 one document at a time, and during conveyance of each document causes the scanner 112 to scan the sheet to generate image data. Subsequently, each document is discharged onto a discharge tray 114.

The image former 120 forms an image by using image data generated by the image reader 110 or image data received from another device by a controller 151. According to an embodiment, imaging units 121Y, 121M, 121C, 121K form yellow (Y), magenta (M), cyan (C), black (K) toner images, respectively.

Toner images of each color formed by the imaging units 121Y, 121M, 121C, 121K are sequentially electrostatically transferred (primary transfer) so as to overlap with each other on an intermediate transfer belt 122, thereby forming a color toner image. The intermediate transfer belt 122 is an endless belt, and conveys the color toner image to a secondary transfer roller pair 123.

At the same time, a sheet feed roller 132 feeds out a sheet S from a sheet feed cassette 131a, 131b, 131c, 131d of a sheet type specified by a user. For example, a sheet S contained in a first sheet feed cassette 131a is fed out by a sheet feed roller 132a.

A sheet S contained in a second sheet feed cassette 131b is fed out by a sheet feed roller 132b, and conveyed to a timing roller pair 124 by a vertical conveyance roller 133b. A sheet S contained in a third sheet feed cassette 131c is fed out by a sheet feed roller 132c, and conveyed to the timing roller pair 124 by a vertical conveyance roller 133c and the vertical conveyance roller 133b.

Similarly, a sheet S contained in a fourth sheet feed cassette 131d is fed out by a sheet feed roller 132d, and conveyed to the timing roller pair 124 by a vertical conveyance roller 133d and the vertical conveyance rollers 133c, 133b. Further, a sheet S placed on the manual feed tray (not illustrated) is fed out by a sheet feed roller 141 and conveyed to the timing roller pair 124.

Sheet feed sensors 134a, 134b, 134c, 134d, 142 are disposed downstream in the sheet conveyance direction from the sheet feed rollers 132a, 132b, 132c, 132d, 141, respectively, and sheet feed timing is detected by detecting a leading edge of a sheet.

Sheet type of a sheet S conveyed as described above is determined on the conveyance path to the timing roller pair 124 by using an optical sensor and an ultrasound sensor described below. Further, skew of the sheet S is corrected by bringing the leading edge thereof into contact with the timing roller pair 124 and causing the sheet S to bend to form an arch. Subsequently, rotational drive of the timing roller pair 124 is started in synchronization with secondary transfer timing, and the sheet S is conveyed to the secondary transfer roller pair 123.

The secondary transfer roller pair 123 form a secondary transfer nip 125 where they sandwich the intermediate transfer belt 122. Further, a secondary transfer bias is applied between the two rollers of the secondary transfer roller pair 123 to electrostatically transfer the color toner image carried by the intermediate transfer belt 122 to the sheet S at the secondary transfer nip 125 (secondary transfer). At this time, when the sheet S is electrically grounded, positive charge flows out and negatively-charged toner cannot be electrostatically adsorbed.

The sheet S to which the color toner image is transferred is conveyed to the fixing device 100, the color toner image is thermally fixed, and the sheet S is then discharged onto the sheet discharge tray 127 by the discharge roller pair 126.

The controller 151 monitors and controls operations of each unit of the image forming device 1.

[2] Sheet Type Identification

The following describes structure for identifying sheet types.

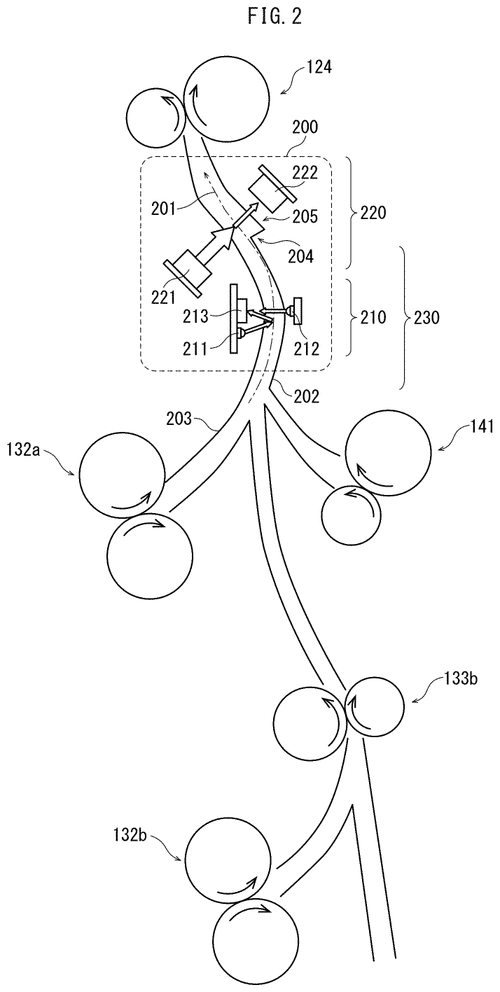

A sheet S fed from the sheet feed cassettes 131a, 131b, 131c, 131 d or the manual feed tray by the sheet feed rollers 132a, 132b, 132c, 132d is conveyed to the timing roller pair 124 via the conveyance path 201, which has an S-shape formed by the conveyance guide 202 that has the step 204 and the conveyance guide 203 facing the conveyance guide 202, as illustrated in FIG. 2. A media detection sensor 200 is disposed alongside the conveyance path 201. The media detection sensor 200 includes an optical sensor 210 and an ultrasound sensor 220 in this order along the conveyance direction.

The optical sensor 210 is disposed upstream in the conveyance direction from the step 204, and includes a reflection light source 211, a transmission light source 212, and a light reception sensor 213. The reflection light source 211 and the transmission light source 212 are, for example, light emitting diodes (LEDs), but other light sources may be used. Further, the light reception sensor 213 may use a photodiode (PD), or may use another sensor.

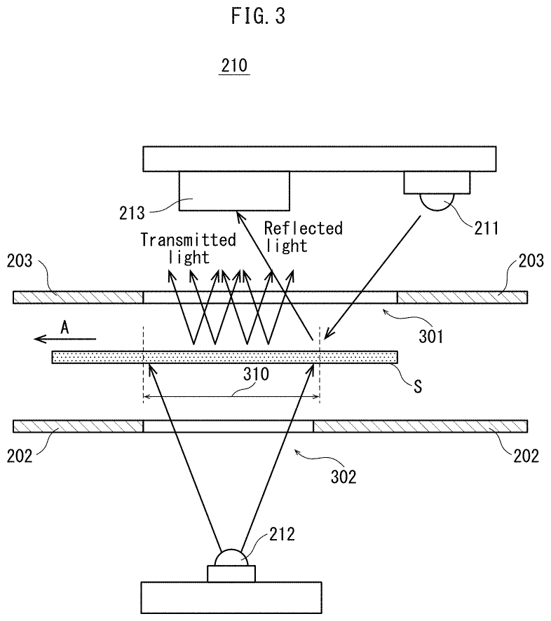

The reflection light source 211 irradiates the sheet S conveyed in a direction A with light in a light irradiation range 310 via a through hole 301 provided in the conveyance guide 203, as illustrated in FIG. 3. The transmission light source 212 irradiates the sheet S conveyed in the direction A with light in the light irradiation range 310 via a through hole 302 provided in the conveyance guide 202. The light reception sensor 213 detects light reflected from and transmitted through the sheet S.

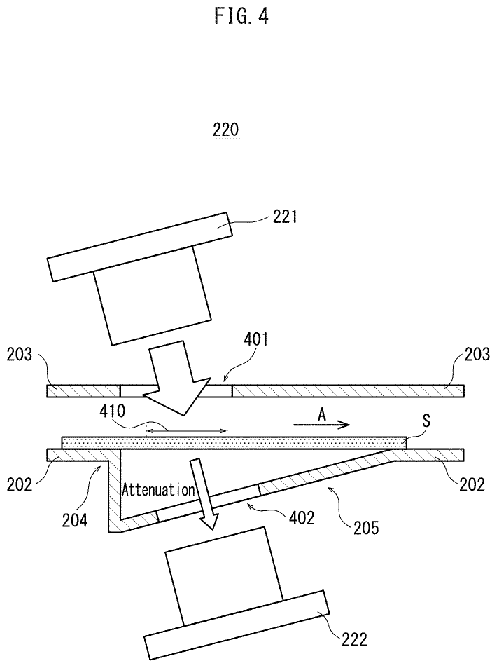

The ultrasound sensor 220 is disposed downstream in the conveyance direction from the step 204, and includes an ultrasound transmitter 221 and an ultrasound receiver 222 as illustrated in FIG. 4. The ultrasound transmitter 221 irradiates the sheet S conveyed in the direction A with ultrasound waves in an ultrasound irradiation range 410 via a through hole 401 provided in the conveyance guide 203. The ultrasound waves are transmitted through the sheet S, attenuated in intensity according to the sheet type of the sheet S, and are incident on the ultrasound receiver 222 via a through hole 402 provided in an angled portion 205 of the conveyance guide 202. The ultrasound receiver 222 detects intensity of ultrasound transmitted through the sheet S.

The conveyance path 201 has a curved portion 230 where the conveyance guide 203 is curved towards the conveyance guide 202. When the sheet S is fed out by the sheet feed roller 132a and pressed against the conveyance guide 202, elasticity of the sheet S causes an elastic restoring force to return to a flat state, and therefore the sheet S is conveyed in contact with the conveyance guide 202.

According to at least one embodiment, the step 204 is at a downstream end of the curved portion 230 in the conveyance direction. When the step 204 is at the downstream end of the curved portion 230 or at a central portion of the curved portion 230 in the conveyance direction, the sheet S always contacts a corner of the step 204. Further, the optical sensor 210 is disposed alongside the curved portion 230, and therefore the sheet S contacts the conveyance guide 202 on the conveyance path 201 from the optical sensor 210 to the step 204.

The downstream portion of the step 204 in the conveyance direction recedes from the conveyance path 201, and therefore when the sheet S passes the step 204 the sheet S is separated from the conveyance guide 202. Accordingly, the sheet S is separated from the conveyance guide 202 in the ultrasound irradiation range of the ultrasound sensor 220.

The angled portion 205 of the conveyance guide 202 is angled with respect to the conveyance path 201 downstream of the step 204, and the ultrasound receiver 222 is disposed alongside the angled portion 205. The ultrasound transmitter 221 is disposed facing the ultrasound receiver 222, and emits ultrasound waves in a direction perpendicular to the angled portion 205. Therefore, an irradiation direction of ultrasound waves from the ultrasound transmitter 221 obliquely intersects the conveyance direction (conveyance path 201). Therefore, interference between ultrasound waves emitted from the ultrasound transmitter 221 and ultrasound waves reflected from the sheet S that changes intensity of ultrasound waves can be prevented. Accordingly, detection accuracy of the ultrasound sensor 220 can be stabilized.

Further, as illustrated in FIG. 2, the optical sensor 210 is disposed upstream of the ultrasound sensor 220 in the conveyance direction and the ultrasound transmitter 221 of the ultrasound sensor 220 emits ultrasound waves angled downstream in the conveyance direction. In other words, the ultrasound transmitter 221 emits ultrasound waves in a direction away from the optical sensor 210. Thus, the ultrasound transmitter 221 results in less vibration of the sheet S in the light irradiation range of the optical sensor 210 than when ultrasound waves are emitted towards the optical sensor 210.

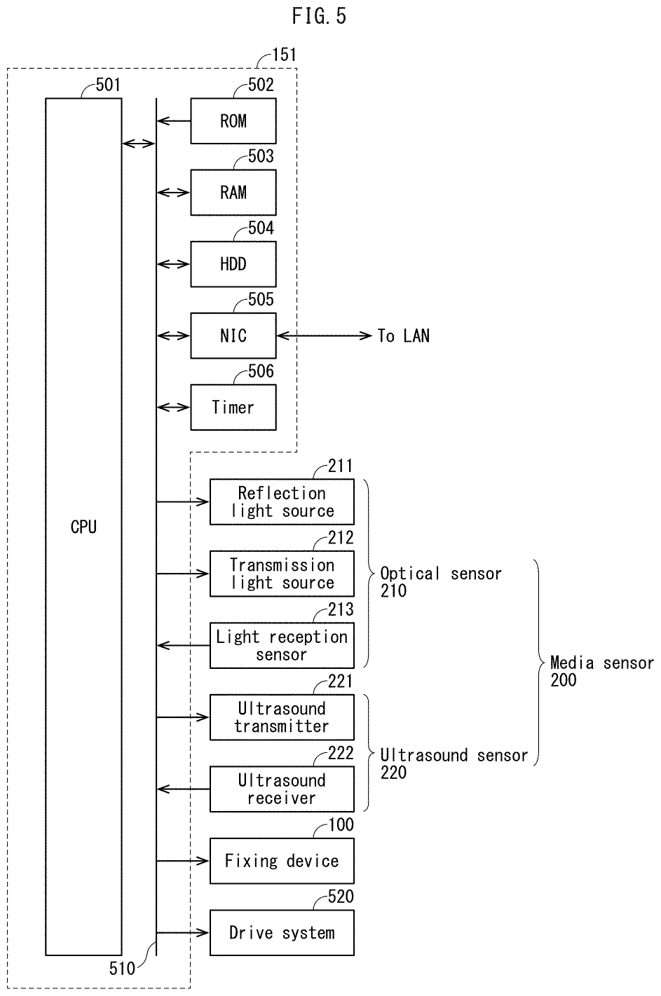

The controller 151 identifies sheet type of the sheet S by referencing a detection signal of the media detection sensor 200. As illustrated in FIG. 5, the controller 151 includes a central processing unit (CPU) 501, read only memory (ROM) 502, random access memory (RAM) 503, and the like, and the CPU 501 etcetera use an internal bus 510 to connect and communicate with each other.

When the CPU 501 is reset when the image forming device 1 is powered on, for example, the CPU 501 reads a boot program from the ROM 502, starts up, and executes an operating system (OS) and control program read from a hard disk drive (HDD) 504 while using the RAM 503 as a working storage area. Thus, the CPU 501 references detection results of the optical sensor 210 and the ultrasound sensor 220, and controls operations of the optical sensor 210, the ultrasound sensor 220, the fixing device 100, and a drive system 520.

The drive system 520 is a drive source that causes operation of the imaging units 121Y, 121M, 121C, 121K, drives movement of the intermediate transfer belt 122, and drives rotation of the secondary transfer roller pair 123, the timing roller pair 124, the discharge roller pair 126, and the sheet feed rollers 132a, 132b, 132c, 132d, 141.

The controller 151 uses a network interface card (NIC) 505 to communicate with another device via a local area network (LAN) or the Internet. Thus, for example, an image forming job can be received from another device. Further, when a timer 506 sets a time, the CPU 501 can receive a notification after the time has elapsed.

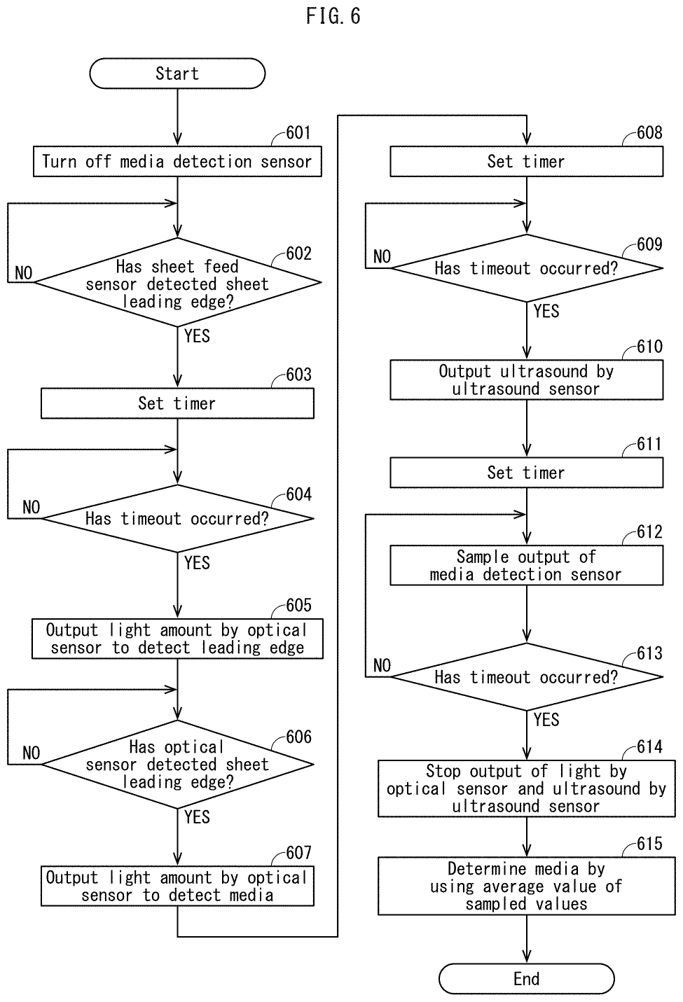

When determining sheet type, as illustrated in FIG. 6, the controller 151 first turns off the media detection sensor 200, stopping detection by the optical sensor 210 and the ultrasound sensor 220, and starts supply of a sheet by the sheet feed roller 132a. 132b, 132c, 132d, 141 (S601).

When one of the sheet feed sensors 134a, 134b, 134c, 134d, 142 detects a leading edge of a sheet (S602: “YES”), a defined time is set in the timer 506 (603). Subsequently, when the timer 506 times out (S604: “YES”), the transmission light source 212 of the optical sensor 210 emits an appropriate amount of light for detecting the leading edge of the sheet towards the conveyance path (S605).

Subsequently, when it is estimated that the sheet blocks light emitted from the transmission light source 212 due to a decrease in light received by the light reception sensor 213 of the optical sensor 210, it is determined that the optical sensor 210 has detected the leading edge of the sheet (S606: “YES”). Then the reflection light source 211 and the transmission light source 212 of the optical sensor 210 irradiate the sheet with an appropriate amount of light for media detection, or in other words for determining the type of the sheet, (S607) while a time required for the sheet to reach an appropriate position for the media detection from its current position is set in the timer 506 (S608).

Subsequently, when the timer 506 times out (S609: “YES”), it is considered that the sheet has reached an appropriate position for media detection using both the optical sensor 210 and the ultrasound sensor 220, and therefore output of ultrasound waves by the ultrasound transmitter 221 of the ultrasound sensor 220 is started (S610) and a time required for the sheet to leave the position suitable for media detection is set in the timer 506 (S611).

Next, the controller 151 records detection values (sampling values) with reference to detected light amount of the light reception sensor 213 of the optical sensor 210 and detected intensity of the ultrasound receiver 222 of the ultrasound sensor 220 (S612). If the timer 506 has not timed out (S613: “NO”), it is determined that the sheet is still in an appropriate position for media detection, and therefore the sampling of step S612 is repeated.

If a time out has occurred (S613: “YES”), light output from the reflection light source 211 and the transmission light source 212 of the optical sensor 210 is stopped, and ultrasound output of the ultrasound transmitter 221 of the ultrasound sensor 220 is stopped (S614). Subsequently, an average value is calculated for the sampling values of the light reception sensor 213 of the optical sensor 210 and an average value is calculated for the sampling values of the ultrasound receiver 222 of the ultrasound sensor 220, and the type of the sheet S is determined from a combination of the average values (S615).

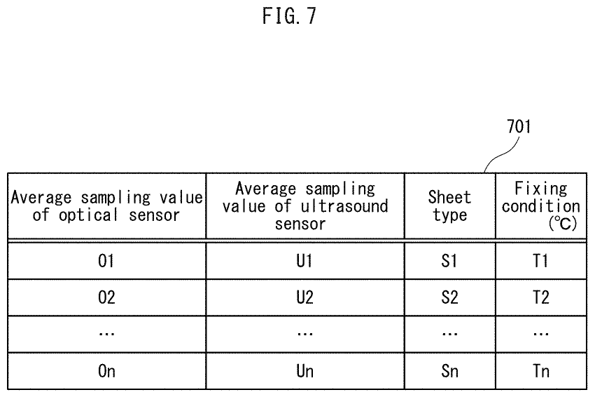

For determining sheet type, for example, a sheet type determination table 701 as illustrated in FIG. 7 may be used. In the sheet type determination table 701, fixing temperature is also stored as a fixing condition corresponding to sheet type in the sheet type determination table 701 illustrated in FIG. 7, but a table associating sheet type with fixing condition may be provided separately. Other conditions may also be provided, such as sheet conveyance speed (the thicker the sheet, the slower the speed) and secondary transfer bias (the thicker the sheet, the higher the bias).

[3] Structure for Suppressing Vibration Propagation in Sheet S

The following describes how vibration of the sheet S caused by irradiation with ultrasound waves from the ultrasound sensor 220 is suppressed from propagating to the light irradiation range of the optical sensor 210, thereby suppressing deterioration of detection accuracy of the optical sensor 210, for each sheet feed source of the sheet S.

(3-1) Sheet Feed from the First Sheet Feed Cassette 131a

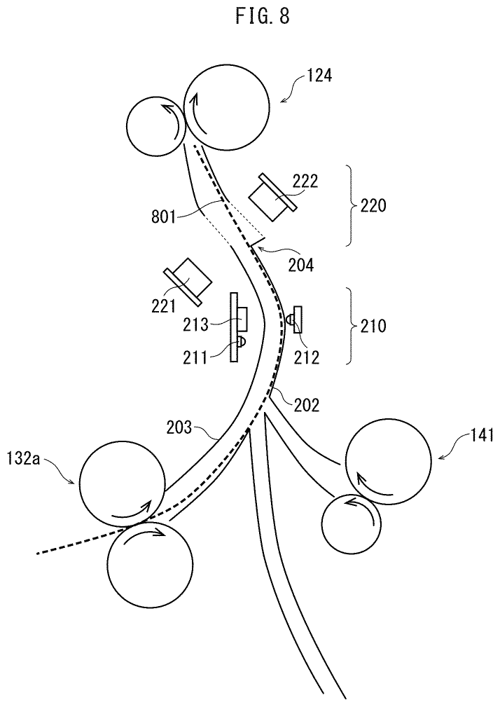

When the sheet S is fed from the first sheet feed cassette 131a, the sheet S is conveyed along a conveyance path 801 illustrated in FIG. 8. More specifically, when the sheet S is fed from the first sheet feed cassette 131a, the sheet S passes through the light irradiation range of the optical sensor 210 along the conveyance guide 202, then passes through the ultrasound irradiation range of the ultrasound sensor 220 and hits the conveyance nip of the timing roller pair 124.

The conveyance guides 202, 203 are curved so that an outside of the curve is towards the right side of FIG. 8 (towards the transmission light source 212 of the optical sensor 210) in the light irradiation range of the optical sensor 210, but the conveyance guide 202 includes the step 204 in the ultrasound irradiation range of the ultrasound sensor 220, where the conveyance guide 202 is bent such that a corner of the step 204 protrudes towards the left side of FIG. 8. Due to the shape of the conveyance guides 202, 203, the conveyance path 801 for the sheet S is bent into an S shape, and therefore when a portion of the sheet S downstream in the conveyance direction is in the light irradiation range of the optical sensor 201 and a portion of the sheet S upstream in the conveyance direction is in the ultrasound irradiation range of the ultrasound sensor 220, the sheet S is brought into contact with the conveyance guide 202 on a path from the light irradiation range of the optical sensor 210 to the ultrasound irradiation range of the ultrasound sensor 220.

Accordingly, even if the sheet S vibrates in the ultrasound irradiation range due to emission of ultrasound waves by the ultrasound sensor 220, vibration of the sheet S is regulated by the contact of the sheet S with the conveyance guide 202, thereby preventing propagation of the vibration to the light irradiation range of the optical sensor 210, preventing vibration of the sheet S in the light irradiation range, and preventing a decrease in detection accuracy by the optical sensor 210.

Accordingly, it is not necessary to provide a dedicated conveyance roller between the optical sensor 210 and the ultrasound sensor 220 to prevent propagation of vibration, and therefore sheets can be conveyed stably without roller eccentricity, deterioration over time, and sheet fluttering due to slippage from paper dust. Further, cost reduction and space-saving can be achieved.

(3-2) Sheet Feed from Manual Feed Tray

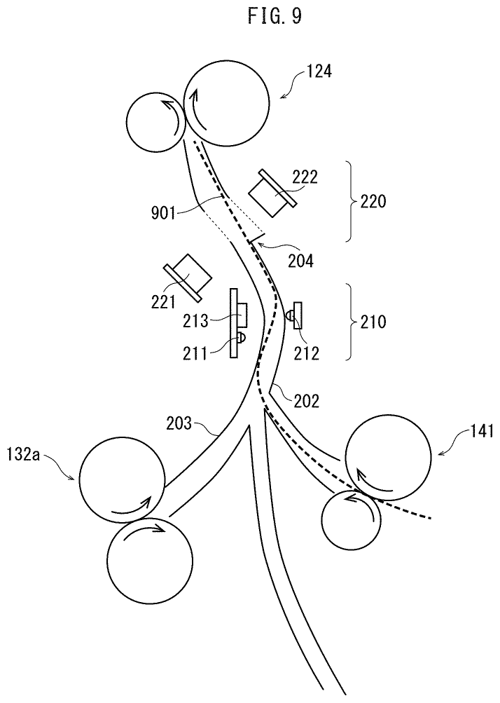

When the sheet S is fed from the manual feed tray, the sheet S is conveyed along a conveyance path 901 as illustrated in FIG. 9. When the sheet S is fed out from the manual feed tray by the sheet feed roller 141, the sheet S hits the conveyance guide 203 and is temporarily conveyed along the conveyance guide 203.

As described above, the conveyance guide 203 curves so that the outside of the curve protrudes towards the right side of FIG. 9 (towards the transmission light source 212 of the optical sensor 210) in the light irradiation range of the optical sensor 210. Further, the sheet S being conveyed along the conveyance guide 203 tries to become flat due its own elasticity (elastic restoring force), and therefore proceeds away from the curved portion of the conveyance guide 203 towards the conveyance guide 202.

When the sheet S passes through the light irradiation range of the optical sensor 210, the sheet S hits the conveyance guide 202 and is pressed against the conveyance guide 202 by its own elasticity, and therefore proceeds along the conveyance guide 202 in contact with the conveyance guide 202. Subsequently, when the sheet S passes over the step 204, the sheet S enters the ultrasound irradiation range of the ultrasound sensor 220.

As described above, the sheet S is in contact with the conveyance guide 202 from leaving the light irradiation range of the optical sensor 210 to entering the ultrasound irradiation range of the ultrasound sensor 220, and therefore vibration of the sheet S caused by ultrasound irradiation is regulated by the conveyance guide 202. Accordingly, a decrease in detection accuracy by the optical sensor 210 due to vibration of the sheet S propagating to the light irradiation range of the optical sensor 210 can be prevented.

Accordingly, it is not necessary to provide a dedicated conveyance roller between the optical sensor 210 and the ultrasound sensor 220 to prevent propagation of vibration, and therefore sheets can be conveyed stably without roller eccentricity, deterioration over time, and sheet fluttering due to slippage from paper dust. Further, cost reduction and space-saving can be achieved.

(3-3) Sheet Feed from the Second Sheet Feed Cassette 131b

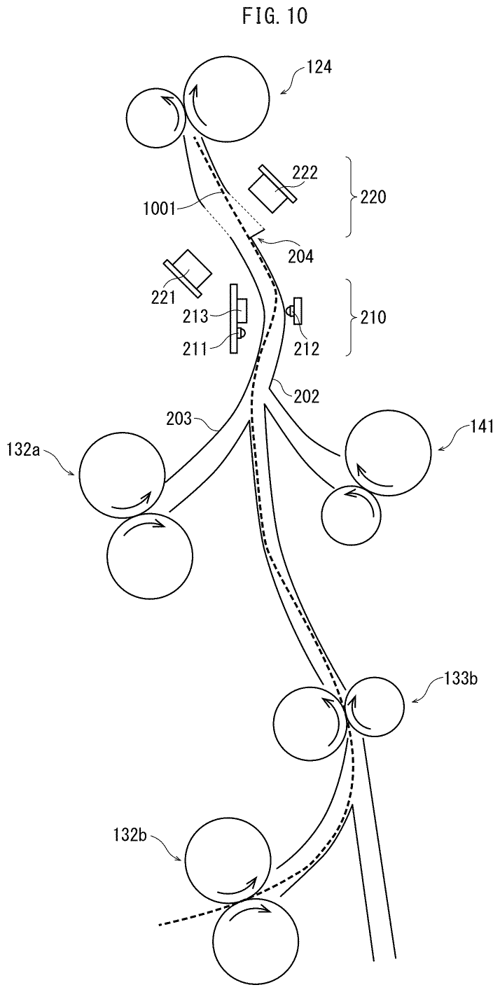

When the sheet S is fed from the second sheet feed cassette 131b, the sheet S is conveyed along a conveyance path 1001 illustrated in FIG. 10. When the sheet S is fed from the second sheet feed cassette 131b by the sheet feed roller 132b and is conveyed upwards by the vertical conveyance roller 133b, the sheet S hit the curved portion of the conveyance guide 203 and is temporarily conveyed along the conveyance guide 203. However, the sheet S tries to flatten due to its own elasticity, and therefore proceeds away from the curved portion of the conveyance guide 203 towards the conveyance guide 202.

The conveyance path 1001 after separation from the curved portion of the conveyance guide 203 is the same as the conveyance path 901 described above. Accordingly, similarly to when a sheet is fed from the manual feed tray, vibration of the sheet S in the light irradiation range of the optical sensor 210 is suppressed, and therefore a decrease in detection accuracy of the optical sensor 210 can be prevented.

The same effect is achieved when the sheet S is fed from the third sheet feed tray 131c and from the fourth sheet feed tray 131d.

Accordingly, it is not necessary to provide a dedicated conveyance roller between the optical sensor 210 and the ultrasound sensor 220 to prevent propagation of vibration, and therefore sheets can be conveyed stably without roller eccentricity, deterioration over time, and sheet fluttering due to slippage from paper dust. Further, cost reduction and space-saving can be achieved.

[4] Modifications

Although description is herein provided based on an embodiment, the present disclosure is of course not limited to the embodiment described above, and the following modifications can be implemented.

(4-1) According to at least one embodiment, the step 204 is provided upstream of the ultrasound irradiation range in the conveyance direction between the light irradiation range of the optical sensor 210 and the ultrasound irradiation range of the ultrasound sensor 220, but of course the present disclosure is not limited to this example and includes the following examples.

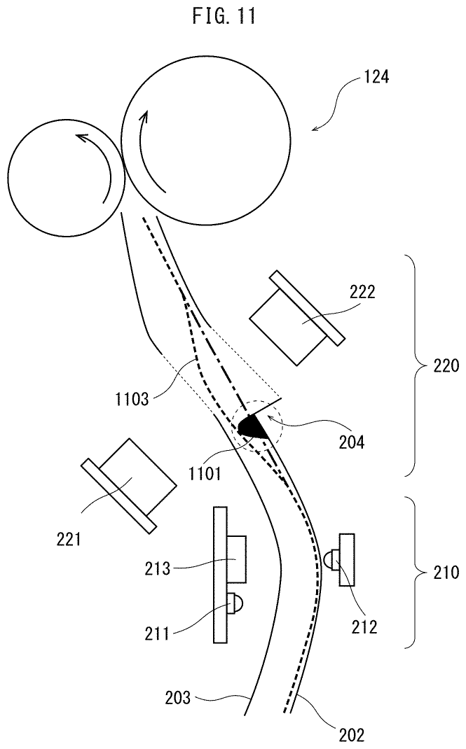

For example, as illustrated in FIG. 11, the conveyance guide 202 may include a protrusion 1101 on the step 204. The protrusion 1101 is a rib-shaped member elongated in a sheet width direction, and may be attached to a main body of the conveyance guide 202 or integrally formed with the main body of the conveyance guide 202. Further, the protrusion 1101 may be provided over an entire width in the sheet width direction of the conveyance guide 202, or may be narrower than the entire width of the conveyance guide 202 as long as propagation of vibration of the sheet S can be suppressed. The width of the protrusion 1101 in the sheet conveyance direction is also preferably a size capable of suppressing propagation of vibrations of the sheet S.

Thus, curvature of the sheet S on a conveyance path 1103 when the conveyance guide 202 has the protrusion 1101 is larger than curvature of the sheet S on a conveyance path 1102 when the conveyance guide 202 does not have the protrusion 1101, and therefore the elastic restoring force due to elasticity of the sheet S is larger.

Accordingly, the sheet S is pressed against the protrusion 1101 with an elastic restoring force that is larger than an elastic restoring force pressing the sheet S against the conveyance guide 202 without the protrusion 1101, and therefore vibration of the sheet S can be regulated more reliably than when the protrusion 1101 is not present. Thus, a decrease in detection accuracy of the optical sensor 210 can be prevented.

Accordingly, it is not necessary to provide a dedicated conveyance roller for prevention of vibration propagation, and therefore sheets can be conveyed stably without roller eccentricity, deterioration over time, and sheet fluttering due to slippage from paper dust. Further, cost reduction and space-saving can be achieved.

Multiples of the protrusion 1101 may be provided. For example, if positions where the sheet S contacts the conveyance guide 202 are different depending on conditions such as supply source and sheet type of the sheet S, it can be effective to provide the protrusion 1101 at multiple contact positions.

(4-2) According to at least one embodiment, vibration is suppressed from propagating along the conveyance direction, but the present disclosure is of course not limited to this example, and includes the following examples.

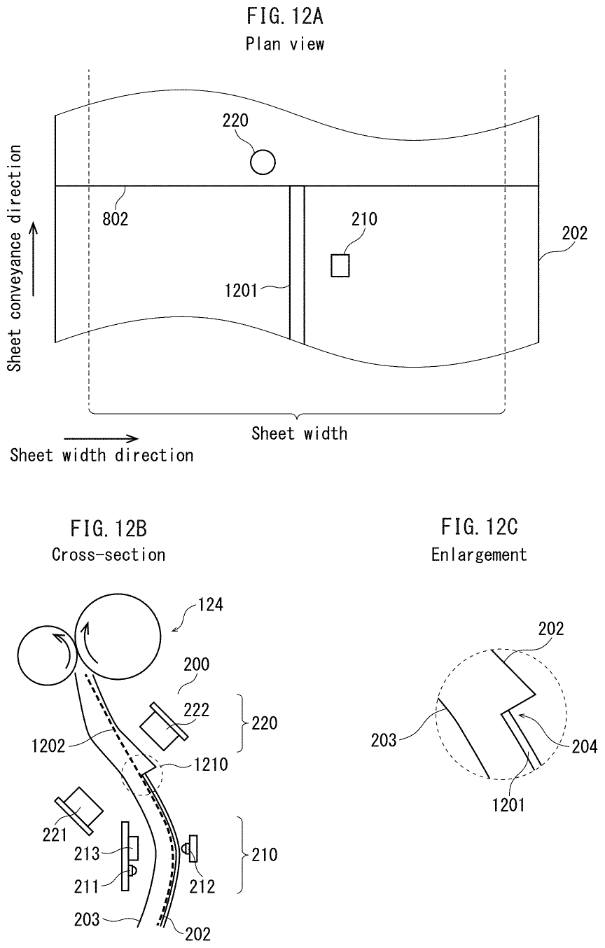

For example, as illustrated in FIG. 12A, the conveyance guide 202 may include a protrusion 1201 elongated in the sheet conveyance direction between the optical sensor 210 and the ultrasound sensor 220 in the sheet width direction of the conveyance guide 202, in order to suppress propagation of vibration of the sheet S. In FIG. 12A, the protrusion 1201 is disposed centrally in the sheet width direction of the conveyance guide 202. Further, as illustrated in FIG. 12B, the protrusion 1201 is a rib-shaped member that extends along the sheet conveyance direction with a downstream end at the step 204.

An upstream end of the protrusion 1201 in the sheet conveyance direction is preferably upstream of the light irradiation range of the optical sensor 210. Further, size of the protrusion in the sheet width direction is preferably such that vibration of the sheet S caused by irradiation by ultrasound waves by the ultrasound sensor 220 can be suppressed from propagating to the light irradiation range of the optical sensor 210. Further, the protrusion 1201 may be attached to the main body of the conveyance guide 202 or may be formed integrally with the main body of the conveyance guide 202.

The protrusion 1201 stands upright from a main surface of the conveyance guide 202, and is therefore closer to the conveyance guide 203 than the main surface of the main body of the conveyance guide 202. Accordingly, the sheet S is pressed against the protrusion 1201 with an elastic restoring force that is larger than an elastic restoring force pressing the sheet S against the conveyance guide 202 without the protrusion 1201, and therefore vibration of the sheet S can be regulated more reliably than when the protrusion 1201 is not present.

Accordingly, it is not necessary to provide a dedicated conveyance roller for prevention of vibration propagation, and therefore sheets can be conveyed stably without roller eccentricity, deterioration over time, and sheet fluttering due to slippage from paper dust. Further, cost reduction and space-saving can be achieved.

Further, multiples of the protrusion 1201 in different positions in the sheet width direction may be provided. This structure can regulate vibration of the sheet S through contact with the sheet S at a plurality of locations, further increasing reliability of suppression of vibration of the sheet S.

(4-3) According to at least one embodiment, material of the conveyance guide 202 and the protrusions 1101, 1201 is not specified, but a vibration absorbing material may be used for the protrusions 1101, 1201 and portions of the conveyance guide 202 that come into contact with the sheet S. Accordingly, vibration of the sheet S can be suppressed more efficiently.

(4-4) According to at least one embodiment, a fixing condition is changed according to sheet type, but the present disclosure is of course not limited to this example. Instead of or in addition to a fixing condition, a development condition for developing a toner image on a photosensitive drum, a transfer condition for transferring a toner image to a sheet, and the like may be changed and controlled according to sheet type.

(4-5) According to at least one embodiment, the ultrasound sensor 220 is disposed downstream of the optical sensor 210 in the conveyance direction, but the present disclosure is of course not limited to this example. Even if the ultrasound sensor 220 is disposed upstream of the optical sensor 210 in the conveyance direction, the same effect can be obtained through application of the present disclosure.

(4-6) According to at least one embodiment, and as illustrated in FIG. 7, a sheet type and/or a fixing condition are determined from a combination of a sampling average value of detection output from the optical sensor 210 and a sampling average value of a detection output from the ultrasound sensor 220, but the present disclosure is of course not limited to this example.

For example, a basis weight table that stores combinations of sampling average values of detection output from the optical sensor 210 and basis weights of the sheet S may be stored in advance in the HDD 504, and the basis weight of the sheet S may be specified from the sampling average value of the detection output from the optical sensor 210. If the basis weight of the sheet S is specified, a fixing condition can be set according to the basis weight.

Further, if the sheet S is actually an envelope, a fixing temperature needs to be higher than if the sheet S is a single sheet for which an amount of reflected light is the same. On the other hand, intensity of ultrasound after transmission, which changes depending on the number of sheets, may be referenced in order to determine whether or not the sheet S is actually an envelope, by using the sampling average value of the detection output from the ultrasound sensor 220. By determining whether or not the sheet S is actually an envelope and setting a fixing condition according to a result of the determination, fixing image quality can be improved if the sheet S is actually an envelope.

(4-7) According to at least one embodiment, the image forming device 1 is a tandem-type color MFP, but the present disclosure is of course not limited to this example. The image forming device 1 may be a color MFP that is not a tandem-type, and may be a monochrome MFP.

(4-8) According to at least one embodiment, the target of the media detection is a sheet, but the present disclosure is of course not limited to this example, and anything on which image forming can be performed may be the target of the media detection. For example, an envelope, overhead projector film, recycled paper, postcard, etc., may be the target of the media detection, and are included in the term “sheet”.

[5] Review

According to at least one embodiment, an image forming device is an image forming device including an optical sensor, an ultrasound sensor, and a conveyance guide. The optical sensor and the ultrasound sensor are disposed alongside a conveyance path of a sheet and are used to determine sheet type, and the conveyance guide guides the sheet along the conveyance path. The conveyance guide is structured such that, on the conveyance path between the optical sensor and the ultrasound sensor, the sheet is in contact with the conveyance guide while a portion of the sheet is in a light irradiation range of the optical sensor and a different portion of the sheet is in an ultrasound irradiation range of the ultrasound sensor.

According to at least one embodiment, the conveyance guide is curved along the conveyance path between the optical sensor and the ultrasound sensor such that the sheet is in contact with the conveyance guide.

According to at least one embodiment, the conveyance guide is curved in an S shape along the conveyance path between the optical sensor and the ultrasound sensor.

According to at least one embodiment, the image forming device further includes a plurality of sheet feed apertures through which the sheet can be fed. Regardless of which of the plurality of sheet feed apertures the sheet is fed from, when an amount of light is detected by the optical sensor and ultrasound is detected by the ultrasound sensor, the sheet is in contact with a surface of the conveyance guide on the conveyance path between the optical sensor and the ultrasound sensor.

According to at least one embodiment, the conveyance guide includes one or more protrusions that are disposed at positions where the sheet on the conveyance path comes into contact with the one or more protrusions, which are elongated in a direction of sheet width.

According to at least one embodiment, the conveyance guide includes one or more protrusions that are disposed at positions where the sheet on the conveyance path comes into contact with the one or more protrusions, which are elongated in a direction of sheet conveyance.

According to at least one embodiment, an image forming device is an image forming device including an optical sensor, an ultrasound sensor, a first conveyance guide, and a second conveyance guide. The optical sensor and the ultrasound sensor are disposed alongside a conveyance path of a sheet and are used to determine sheet type. The first conveyance guide guides the sheet along the conveyance path, and the second conveyance guide faces the first conveyance guide across the conveyance path. The conveyance path includes a curved portion where the first conveyance guide defines an inside of a curve of the curved portion and the second conveyance guide defines an outside of the curve of the curved portion. The optical sensor is disposed alongside the curved portion. The first conveyance guide includes a step alongside the conveyance path, disposed between the optical sensor and the ultrasound sensor in a direction of sheet conveyance. After the step in the direction of sheet conveyance, the first conveyance guide is farther away from the conveyance path than before the step in the direction of sheet conveyance.

According to at least one embodiment, the conveyance guide further includes a vibration absorbing member at a position where the sheet comes into contact with the conveyance guide, the vibration absorbing member absorbing vibrations of the sheet.

According to at least one embodiment, the first conveyance guide further includes a vibration absorbing member at a position where the sheet comes into contact with the first conveyance guide, the vibration absorbing member absorbing vibrations of the sheet.

According to at least one embodiment, the ultrasound sensor emits ultrasound waves in a direction angled away from the optical sensor.

According to at least one embodiment, the image forming device further includes a basis weight detector that detects basis weight of the sheet by using an output signal from the optical sensor after the optical sensor detects a leading edge of the sheet and an envelope detector that detects whether or not the sheet is an envelope by using an output signal from the ultrasound sensor after the leading edge of the sheet is conveyed to a detection position of the ultrasound sensor. Further, the optical sensor is disposed upstream of the ultrasound sensor in a direction of sheet conveyance.

According to this structure, when the sheet comes into contact with the conveyance guide between the optical sensor and the ultrasound sensor, vibration of the sheet due to irradiation with ultrasound waves by the ultrasound sensor is regulated so as not to propagate to a light irradiation range of the optical sensor, thereby preventing a decrease in detection accuracy of the optical sensor caused by vibration.

Thus, it is not necessary to provide a conveyance roller as in the prior art, and sheet type can be identified while stability is maintained even during conveyance.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming device comprising:
an optical sensor and an ultrasound sensor disposed alongside a conveyance path of a sheet that are used to determine sheet type; and
a conveyance guide that guides the sheet along the conveyance path, wherein
the conveyance guide is structured such that, on the conveyance path between the optical sensor and the ultrasound sensor, the sheet is in contact with the conveyance guide while a portion of the sheet is in a light irradiation range of the optical sensor and a different portion of the sheet is in an ultrasound irradiation range of the ultrasound sensor.

2. The image forming device of claim 1, wherein
the conveyance guide is curved along the conveyance path between the optical sensor and the ultrasound sensor such that the sheet is in contact with the conveyance guide.

3. The image forming device of claim 2, wherein
the conveyance guide is curved in an S shape along the conveyance path between the optical sensor and the ultrasound sensor.

4. The image forming device of claim 1, further comprising:
a plurality of sheet feed apertures through which the sheet can be fed, wherein
regardless of which of the plurality of sheet feed apertures the sheet is fed from, when an amount of light is detected by the optical sensor and ultrasound is detected by the ultrasound sensor, the sheet is in contact with a surface of the conveyance guide on the conveyance path between the optical sensor and the ultrasound sensor.

5. The image forming device of claim 1, wherein
the conveyance guide includes one or more protrusions that are disposed at positions where the sheet on the conveyance path comes into contact with the one or more protrusions, which are elongated in a direction of sheet width.

6. The image forming device of claim 1, wherein
the conveyance guide includes one or more protrusions that are disposed at positions where the sheet on the conveyance path comes into contact with the one or more protrusions, which are elongated in a direction of sheet conveyance.

7. An image forming device comprising:
an optical sensor and an ultrasound sensor disposed alongside a conveyance path of a sheet that are used to determine sheet type;
a first conveyance guide that guides the sheet along the conveyance path; and
a second conveyance guide facing the first conveyance guide across the conveyance path, wherein
the conveyance path includes a curved portion where the first conveyance guide defines an inside of a curve of the curved portion and the second conveyance guide defines an outside of the curve of the curved portion,
the optical sensor is disposed alongside the curved portion,
the first conveyance guide includes a step alongside the conveyance path, disposed between the optical sensor and the ultrasound sensor in a direction of sheet conveyance, and
after the step in the direction of sheet conveyance, the first conveyance guide is farther away from the conveyance path than before the step in the direction of sheet conveyance.

8. The image forming device of claim 1, the conveyance guide further comprising:
a vibration absorbing member at a position where the sheet comes into contact with the conveyance guide, the vibration absorbing member absorbing vibrations of the sheet.

9. The image forming device of claim 7, the first conveyance guide further comprising:
a vibration absorbing member at a position where the sheet comes into contact with the first conveyance guide, the vibration absorbing member absorbing vibrations of the sheet.

10. The image forming device of claim 1, wherein
the ultrasound sensor emits ultrasound waves in a direction angled away from the optical sensor.

11. The image forming device of claim 7, wherein
the ultrasound sensor emits ultrasound waves in a direction angled away from the optical sensor.

12. The image forming device of claim 1, further comprising:
a basis weight detector that detects basis weight of the sheet by using an output signal from the optical sensor after the optical sensor detects a leading edge of the sheet; and
an envelope detector that detects whether or not the sheet is an envelope by using an output signal from the ultrasound sensor after the leading edge of the sheet is conveyed to a detection position of the ultrasound sensor, wherein
the optical sensor is disposed upstream of the ultrasound sensor in a direction of sheet conveyance.

13. The image forming device of claim 7, further comprising:
a basis weight detector that detects basis weight of the sheet using an output signal from the optical sensor after the optical sensor detects a leading edge of the sheet; and
an envelope detector that detects whether or not the sheet is an envelope by using an output signal from the ultrasound sensor after the leading edge of the sheet is conveyed to a detection position of the ultrasound sensor, wherein
the optical sensor is disposed upstream of the ultrasound sensor in a direction of sheet conveyance.
